(19) United States
(12) Patent Application Publication
(10) Pub. No.: US 2015/0151260 A1
(43) Pub. Date: Jun. 4, 2015

(54) METHOD FOR ADAPTING THE GEOMETRY OF A DISPERION NOZZLE

(71) Applicant: SIEMENS AKTIENGESELLSCHAFT, München (DE)

(72) Inventors: Robert Fleck, Adelsdorf (DE); Werner Hartmann, Weisendorf (DE); Sonja Wolfrum, Erlangen (DE)

(73) Assignee: SIEMENS AKTIENGESELLSCHAFT, München (DE)

(21) Appl. No.: 14/405,675

(22) PCT Filed: May 7, 2013
(86) PCT No.: PCT/EP2013/059504

§ 371 Date: Dec. 4, 2014

(30) Foreign Application Priority Data
Jun. 4, 2012 (DE) 10 2012 209 342.7

(51) Int. Cl. B01F 5/06; B01F 3/08; B01F 5/08

(52) U.S. Cl. CPC B01F 5/069; B01F 5/08; B01F 3/0811

(57) ABSTRACT

A specified geometry of a dispersion nozzle is adapted for a required size distribution of a phase dispersed in a dispersing phase by calculating a shear stress rate S and a relative velocity v0 between phases; determining at least one local maximum stable radius for the dispersed phase using values obtained from Rb=(2σ/CsρLSv0)1/2, where σ indicates surface tension of the dispersed phase, Cs indicates the coefficient of friction of the dispersed phase in the dispersing phase, and ρL indicates density of the dispersing phase; determining the distribution of the local maximum stable radius over a cross-sectional area of the dispersion nozzle; and, if a specified maximum stable radius is exceeded in at least one region of the cross-sectional area, changing the geometry of the dispersion nozzle such that a higher shear stress rate S and/or a higher relative velocity v0 of the phases is achieved at least in some regions.

### CROSS REFERENCE TO RELATED APPLICATIONS

This application is the U.S. national stage of International Application No. PCT/EP2013/059504, filed May 7, 2013 and claims the benefit thereof. The International Application claims the benefits of German Application No. 102012209342.7 filed on Jun. 4, 2012, both applications are incorporated by reference herein in their entirety.

### BACKGROUND

Described below is a method for adapting the geometry of a dispersion nozzle in regard to a required size distribution of a phase dispersed in a dispersing phase by the dispersion nozzle.

The dispersion of substances that cannot be dissolved in each other, or are only partially dissolved in each other, such as gas in liquids or the preparation of oil-water emulsions, the gasification of bio- and chemical reactors and the like is a fundamental part of many industrial processes. In particular processes of this kind are required as key processes for producing multi-phase mixtures in the food industry, chemical industry, the pharmaceutical industry, petrochemistry and in mining (in the case of floatation processes). This requires the production of small and micro bubbles or droplets in sometimes very large volume and mass flows, for which significant amounts of energy are applied.

In particular production of the dispersed phases in a controlled size is required in all applications in order to obtain the desired properties of the dispersion/emulsion.

According to the related art, different types of dispersion nozzle are used for dispersion, in which intensive mixing of the phases to be dispersed takes place. Dispersion is achieved in these nozzles by way of a combination of regions with high shear rates alternating with regions of intensive turbulence for mixing of the phases.

The nozzles are designed according to empirical laws since no conclusive theory about the formation of bubbles or droplets in arrangements of this kind has existed until now.

Empirical and semi-empirical methods, such as the calculation of maximum stable bubble sizes above the critical Weber number of gas bubbles in liquids, can be used to only a very limited extent and in narrow parameter ranges.

### SUMMARY

Described below is a method of the type described in the introduction which allows particularly reliable adjustment of dispersion nozzles so a desired bubble or droplet size of the dispersion produced by the dispersion nozzle can be adjusted particularly reliably.

In a method of this kind for adjusting the geometry of a dispersion nozzle in regard to a required size distribution of a phase dispersed in a dispersing phase by the dispersion nozzle, a shear stress rate S and a relative velocity v₀ between the phases is firstly calculated proceeding from a specified geometry of the dispersion nozzle. The shear stress rate is taken to mean the characteristic of the shear stress over a droplet or bubble of the dispersed phase. For a medium that flows with a linear velocity gradient, S corresponds to the quotient of the difference in velocity of the flowing medium over the extent of the droplet and the diameter of the droplet.

At least one local maximum radius for the dispersed phase is then determined on the basis of the flow conditions in the dispersion nozzle characterized in this way in accordance with the relation

R_{b}=(2σ/C_{S}ρ_{L}Sv₀)^{1/2}

where σ indicates the surface tension of the dispersed phase, C_{S} indicates the coefficient of friction of the dispersed phase in the dispersing phase and ρ_{L} indicates the density of the dispersing phase.

It has been found that in contrast to the Weber number, known from the related art, the maximum radius ascertained in this way allows a much improved estimate of the dispersion conditions to be made. The properties of the dispersion nozzle can be adjusted much more accurately in this way.

To analyze the dispersion properties over the entire dispersion nozzle a distribution of the local maximum stable radius is then determined over a cross-sectional area of the dispersion nozzle—this is also based on the relation given above and the flow conditions in the nozzle determined at the start.

If a specified maximum stable radius is exceeded in at least one region of the cross-sectional area then ultimately the geometry of the nozzle is changed such that a higher shear stress rate S and/or a higher relative velocity v₀ of the phases is achieved at least in some regions.

A nozzle geometry is easily and accurately achieved hereby which during operation of a dispersion nozzle of this kind is capable of adjusting the desired dispersion properties.

It is expedient to perform the calculation of the flow conditions in (a) on the basis of a numerical flow model. Methods of this kind, known also as computational-fluid-dynamics models (CFD), allow a sufficiently detailed picture of the flow parameters in the dispersion nozzle to be obtained with reasonable computing effort. For particularly accurate determination of the flow properties it is expedient to also include the local degree of mixing of the phases in the calculation.

Accuracy can be improved further by weighting the distribution of the local maximum radius with the local portion of the dispersed phase.

The dispersion nozzle can be optimized particularly reliably if after changing the geometry of the dispersion nozzle in (d), then (a) to (d) are iteratively performed until the specified maximum stable radius is not exceeded in any region of the cross-sectional area. Iterative adjustment of this kind ensures that the dispersion nozzle has a geometry that satisfies the requirements made in the simplest way.

### BRIEF DESCRIPTION OF THE DRAWINGS

These and other aspects and advantages will become more apparent and more readily appreciated from the following description of the exemplary embodiments with reference to the drawings, in which:

FIG. 1 is a schematic section through a dispersion nozzle,

FIG. 2 is a schematic diagram of the flow conditions around a droplet of a dispersed medium in a dispersion nozzle,

FIG. 3 is a graph of the dependency between flow rate and maximum stable radius of a dispersed droplet for different local shear stress rates and different models,

FIG. 4 is a graph of the dependency between flow rate and maximum stable radius of a dispersed droplet for different local shear stress rates while simultaneously showing the operating points of different, real dispersion nozzles,

FIG. 5 is a diagram of the distribution of the shear stress rate over a cross-section of a dispersion nozzle,

FIG. 6 is a diagram of the distribution of the flow rate over a cross-section of a dispersion nozzle,

FIG. 7 is a diagram of the distribution of the maximum stable radius over a cross-section of a dispersion nozzle, and

FIG. 8 is a graph of the distribution of the maximum stable radius over different radial sectional planes in the dispersion nozzle in FIG. 7.

### DETAILED DESCRIPTION OF THE PREFERRED EMBODIMENT

Reference will now be made in detail to the preferred embodiments, examples of which are illustrated in the accompanying drawings, wherein like reference numerals refer to like elements throughout.

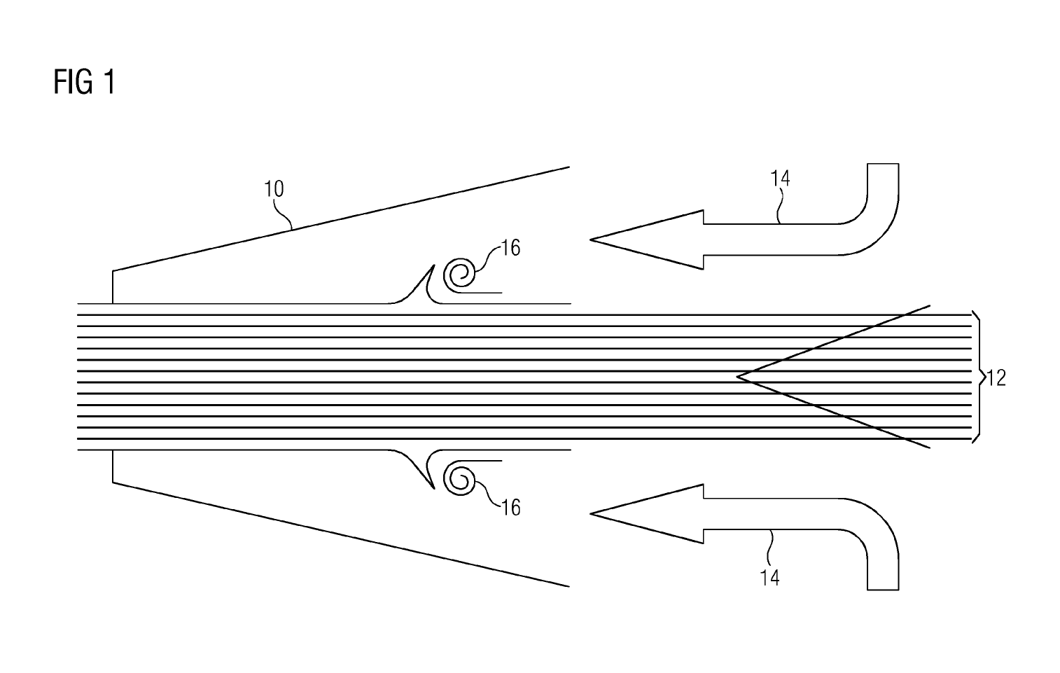

A flow of liquid 12 is mixed with a flow of gas 14 in a dispersion nozzle 10 as is schematically shown in FIG. 1. The flow of gas is broken up into bubbles 18 by the combination of a velocity gradient in the flow of liquid 12 and the presence of turbulent zones 16.

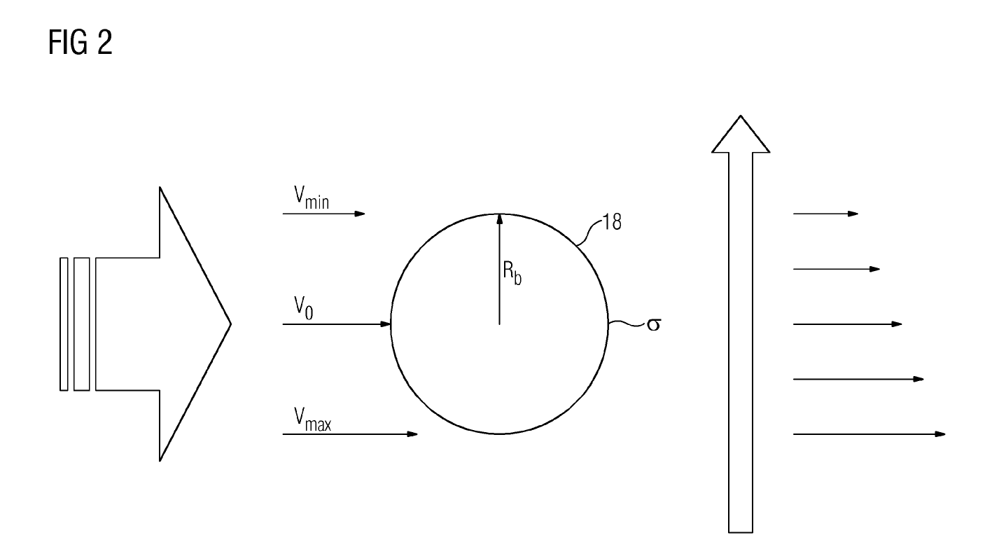

As FIG. 2 shows, a velocity gradient between a maximum velocity Vₘₐₓ, an average relative velocity v₀ and a minimum velocity vₘᵢₙ acts on each bubble 18. The properties of the bubble 18 are also determined by their surface tension σ, the initial bubble radius R_{b}, the density ρₗ of the liquid and the density ρ_{g} of the gas, with the latter, as a rule, being negligible.

It can be determined from these values whether a bubble 18 with a given radius is stable or is divided into smaller bubbles due to the shear forces.

For a bubble in a linear velocity gradient a shear stress rate S results as:

S=(vₘₐₓ−v₀)/R_{b}=(v₀−vₘᵢₙ)/R_{b}=Δv/R_{b} (1)

In the virtually stationary state of equilibrium a pressure differential results over the bubble 18 of

Δp=σ(Rₘᵢₙ⁻¹+Rₘₐₓ⁻¹) (2)

where Rₘᵢₙ and Rₘₐₓ describe the short or long main axis of an ellipsoidal bubble 18. Assuming incompressibility of the bubble 18 a maximum effective pressure pₘₐₓ of

pₘₐₓ=⅛·ρₗC_{S}·(R_{b}S+2v₀)² (3)

results on the side of the bubble 18 on which a flow with velocity Vₘₐₓ acts, where Cₛ indicates the coefficient of friction of a sphere with a radius R_{b}. The minimum effective pressure can be determined analogously, so the pressure differential Δp over the bubble 18 of

Δp=C_{S}ρₗSR_{b}vₒ (4)

results, from which a resulting force

F_{b}=C_{S}ρₗSR_{b}vₒA (5)

can in turn be obtained. Assuming an initially spherical bubble the area A is the effective cross-sectional area, so the force

F_{b}=C_{S}ρₗSvₒR_{b}_{_{—}}ₘᵢₙ³v₀π (6)

results. R_{b}_{_{—}}ₘᵢₙ indicates the short half axis in the case of deformation of the bubble 18 due to the flow.

In transition situations in which the bubble 18 is temporarily deformed by the pressure the bubble 18 initially assumes an oblate shape. The bubble 18 can become instable due to the excitation of shape oscillations and can break up into smaller bubbles if the contact area for the flow exceeds the critical area

A_{crit}=R²_{b}_{_{—}}_{crit}π (7)

The critical radius can be estimated as

R²_{b}_{_{—}}_{crit}=1.44R_{b}_{_{—}}₀ (8)

where R_{b o} indicates the initial bubble radius. A critical cross-sectional area therefore results of

A_{crit}=1.44R_{b}_{_{—}}₀π (9)

With a maximum stable bubble 18 the following equilibrium of forces exists

F_{b}=C_{S}ρₗSR_{b}vₒR_{b}³v₀π=Fₛₜ=2πσR_{b} (10)

between the force F_{b} exerted by the flow and the surface force Fₛₜ. It therefore follows for the maximum stable radius R_{b} of a bubble 18

R_{b}=[(2σ)/(C_{S}ρₗSvₒ)]^{1/2} (11)

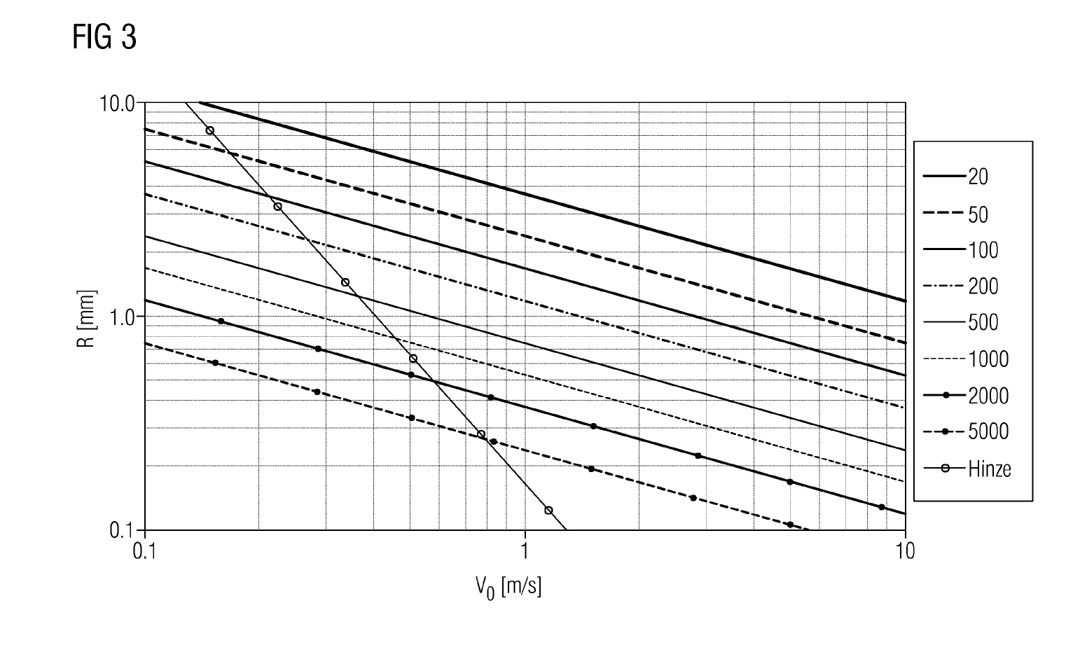

Solutions to equation 11 are plotted for different local shear stress rates in FIG. 3 as a function of the relative velocity between the phases. By contrast, the function marked with open circles indicates the dependency as is obtained on the basis of the semi-empirical approach known from the related art for a critical Weber number of 4.7 (Hinze et al, A.I.Ch.E Journal vol. 1, no. 3, pages 289-295).

It is clear to see that the above-described non-empirical approach provides significantly different values for the maximum stable radius of a bubble 18. The semi-empirical approach assumes unrealistically small bubble radii in particular for high flow velocities, and it has not been possible to confirm these by way of experiments. Such velocities of several m/s to several tens of m/s are particularly important for industrial dispersion nozzles, however,

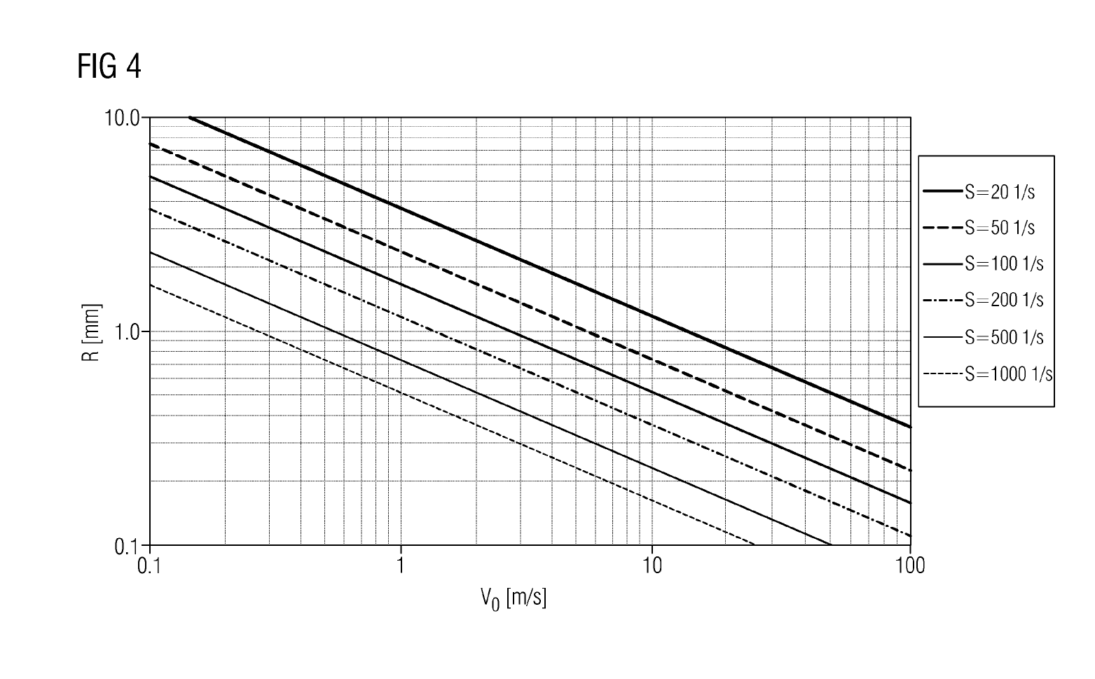

The typical operating parameters for a dispersion nozzle on a laboratory scale and a dispersion nozzle of an industrial floatation cell used in mining are superimposed in FIG. 4 on the graphs already shown in FIG. 3. It is clear to see that these operating points lie in a range in which the semi-empirical approach already no longer assumes any macroscopic bubbles.

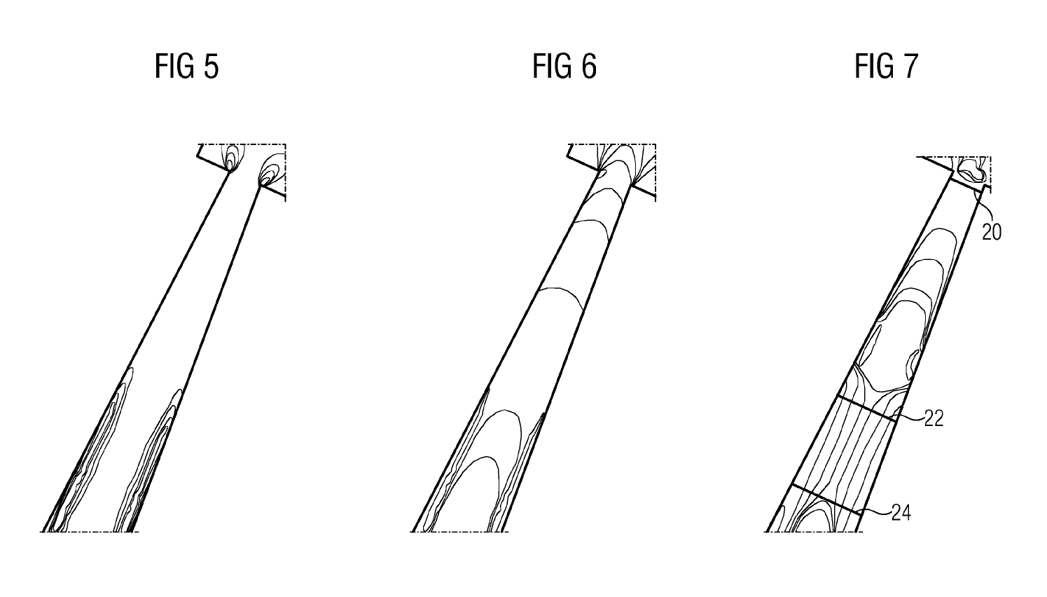

The actually observed bubble radii in these dispersion nozzles lie at the operating points at 0.6-1 mm, and this coincides excellently with the calculated values according to FIG. 4. By way of experiments it may also be observed that much smaller bubbles also form at the nozzle outlet with a gas content of 5-15%. This may be explained by the locally very different shear stress rates and flow velocities over the nozzle cross-section. FIGS. 5 and 6 show a numerical calculation of these values and their local distribution over the nozzle. It can be seen that shear stress rates S of up to 3,000 s⁻¹ and velocities v₀ of up to 25 m/s are attained in particular in the region close to a wall and at the nozzle outlet.

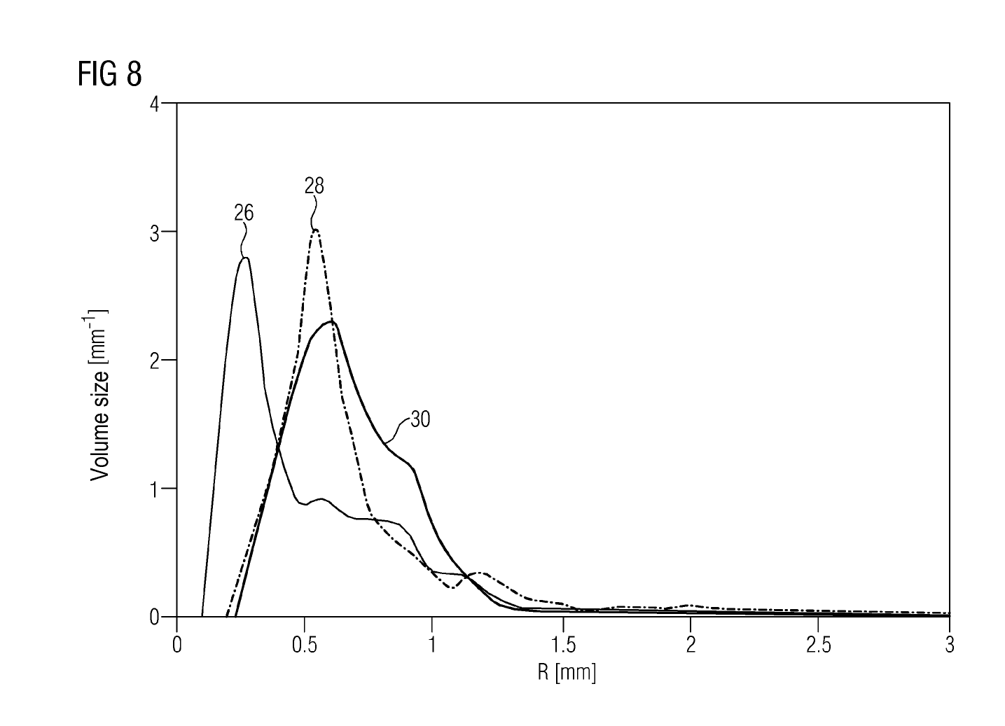

The respectively valid maximum stable radii for bubbles 18 can be calculated from the shear stress rates and velocities calculated in this way, as shown in FIG. 7, on the basis of equation 11 for the individual regions of the dispersion nozzle 10. The respective radial characteristic of the local maximum stable bubble radii is also plotted in the curves 26, 28, 30 in FIG. 8 for three sectional planes 20, 22, 24 through the dispersion nozzle 10.

The local maxima of these curves are again well in line with the values of 0.6-1 mm determined by way of experiments.

It is possible to optimize the geometry of dispersion nozzles on the basis of the illustrated numerical simulation of the flow conditions in a dispersion nozzle and the calculation of the local maximum stable radii according to equation 11.

For this purpose the distribution of the local shear stress rates S, the relative velocities v₀ of the phases and the local degree of mixing is firstly calculated for a specified geometry of the dispersion nozzle 10 and for the specified operating parameters, such as mass flows, volume flows or the like, in the manner described by fluid dynamic simulation. The distribution of the local maximum radii can be determined from equation 11. After weighting with the local dispersing agent content the distribution of the bubble or droplet sizes can then be determined over sectional planes of the dispersion nozzle 10 flowed through.

If this distribution differs from a required distribution of the bubble or droplet sizes, the geometric parameters of the dispersion nozzle are changed in such a way that in the case of calculated droplet or bubble radii that are too large, higher sheer stress rates and/or relative velocities are attained in fundamental parts of the dispersion nozzle 10.

This process can be iteratively repeated on the basis of the newly specified nozzle geometry until a nozzle geometry is obtained which produces the desired distribution of the droplet or bubble radii.

Dispersion nozzles 10 can be iteratively optimized quickly and reliably hereby.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-3. (canceled)

4. A method for adapting dispersion nozzle geometry in regard to a required size distribution of a phase dispersed in a dispersing phase by the dispersion nozzle, comprising:
calculating, from a specified geometry of the dispersion nozzle, a distribution of each shear stress rate S and a relative velocity v₀ between the phases based on a numerical flow model to obtain flow parameters in the dispersion nozzle,
determining several local maximum stable radii for a dispersed phase from values obtained by said calculating using R_{b}=(2σ/C_{S}σ_{L}Sv₀)^{1/2}, where σ represents surface tension of the dispersed phase, C_{S} represents a coefficient of friction of the dispersed phase in the dispersing phase and ρ_{L} represents density of the dispersing phase;
determining distribution of a local maximum stable radius over a cross-sectional area of the dispersion nozzle; and
changing the dispersion nozzle geometry, if a specified maximum stable radius is exceeded in at least one region of the cross-sectional area, in accordance with an iteration method, in which said calculating, said determining of the several local maximum stable radii and said determining distribution of the local maximum stable radius are iteratively performed until the specified maximum stable radius is not exceeded in any region of the cross-sectional area, such that at least one of a higher shear stress rate and a higher relative velocity of the phases is achieved at least in some regions.

5. The method as claimed in claim 4, further comprising calculating a local degree of mixing of the phases.

6. The method as claimed in claim 5, wherein the distribution is weighted based on local content of the dispersed phase, with high shear rates alternating with regions of turbulence for mixing of the phases.

7. The method as claimed in claim 4, wherein the distribution is weighted based on local content of the dispersed phase, with high shear rates alternating with regions of turbulence for mixing of the phases.
